(19) United States
(12) Patent Application Publication
(10) Pub. No.: US 2026/0190182 A1
(43) Pub. Date: Jul. 2, 2026

(54) HANDLING EMERGENCY SITUATIONS

(71) Applicant: Telefonaktiebolaget LM Ericsson (publ), Stockholm (SE)

(72) Inventors: Jens POSCHER, Aachen (DE); Ralph DETKE, Herzogenrath (DE); Pedro TERCERO, Madrid (ES); Stefan EICHINGER, Pulheim (DE)

(21) Appl. No.: 19/131,287

(22) PCT Filed: Dec. 2, 2022
(86) PCT No.: PCT/EP2022/084246

§ 371 Date: May 20, 2025

(51) Int. Cl. H04W 76/50; H04W 28/02; H04W 64/00

(52) U.S. Cl. CPC H04W 76/50; H04W 28/0268; H04W 64/00

(57) ABSTRACT

A method where an emergency management entity receives from at least a first cellular network a status indicator indicating a radio network outage in its radio network coverage, where a connection to the at least first cellular network is temporarily not possible. The entity generates a coverage map based on the status indicator indicating a first geographical area where the connection to the first cellular network is temporarily not available due to the radio network outage, determines at least one backup cellular network providing coverage in the first geographical area, and transmits, to the at least one backup cellular network, a first emergency request which includes a network identifier of the first cellular network and the first geographical area.

### TECHNICAL FIELD

The present application relates to a method carried out at an emergency management entity, to a method carried out at a radio access node and to a method carried out at a management node. Furthermore the corresponding emergency management entity, the radio access node and the management node are provided. Additionally a system comprising at least some of the entities is provided, a computer program comprising program code and a carrier comprising the computer program.

### BACKGROUND

Public 3GPP networks (2G to 5G) are designed to provide standardized communication services to end users under the coverage of a mobile operator.

The access to those 3GPP networks is owned by one or more national mobile operators who offer subscription packages either post or pre-paid to the end-users. Thus everybody paying for such a package can access the network and services of a specific operator at any time.

When national or international roaming agreements exist, the end-user can experience even higher availability of mobile communication services in her/his home country area but also abroad.

Authentication and authorization play a major role and depending on the 3GPP network release it is done in home and/or visited network. The visited and home network needs to be configured for roaming and deployed with this architecture, and between the operators, Service Level Agreements (SLAs) need to be defined.

During an (partial) outage of the operator network and without national roaming the end-user will not be able to use communication services any longer, except emergency call. This may be acceptable for a certain period of time and under the circumstances that alternative technologies like PSTN and/or WIFI are available.

But in case of a long duration disaster situation where landlines, 3GPP networks and power grids are devastated or not accessible, mobile communication plays an important role to help the affected population to get on demand emergency connectivity beyond emergency call enabling reachability to e.g. relatives and first responders forces.

During a disaster or crisis (natural or manmade), stationary infrastructure is usually damaged or destroyed but mobile infrastructure might be operational or at least has shorter lead time to recover using temporary coverage solutions. The access to these services is limited (due to massive amount of users at the same time frame and location) and prioritized for first responders teams, therefore the public population gets down prioritized or is not able to get basic communication capabilities such as emergency calls or internet access. Capabilities that are essential during crisis or critical situations.

Existing business models related to national and international roaming don't include specific agreements for covering sudden emergency situations. Moreover, those technical solutions are complex in configuration and require dedicated SLAs. In some areas roaming agreements may not be wanted (national roaming) or do not justify the effort and are simply too costly for expected amount of traffic. Even global policies may prevent them.

When a disaster strikes, and mobile communication infrastructure is devastated from one or many operators it's hardly possible to serve the affected population or first responders with basic communication needs. There are well established recovery procedures per single operator and those are having usually short lead times depending on the size of the destruction. But there is no alternative which covers a temporary fallback scenario where resources in emergency situations can be shared across multiple operators without the boundaries of complex business cases.

### SUMMARY

Accordingly, a need exists to improve the communication options in case of an emergency.

This need is met by the features of the independent claims. Further aspects are described in the dependent claims.

According to a first aspect a method is provided which is carried out at an emergency management entity wherein the method comprises the step of receiving a status indicator from at least a first cellular network which indicates a radio network outage in the radio network coverage where a connection to the at least first cellular network is temporarily not possible. The emergency management entity generates a coverage map based on the status indicator which indicates a first geographical area where the connection to the first cellular network is temporarily not available due to the radio network outage. In addition at least one backup cellular network providing coverage in the first geographical area is determined and a first emergency request is transmitted to the at least one backup cellular network which comprises a network identifier of the first cellular network and the first geographical area.

Additionally the corresponding emergency management entity is provided comprising a memory and at least one processing unit, wherein the memory contains instructions executable by the at least one processing unit. The emergency management entity is operative to work as discussed above or as discussed in further detail below.

The emergency management entity helps to enable a coordination of network resources during a radio network outage, which may occur in view of an unforeseen event. The generated coverage map helps to make sure that in an emergency situation a mobile user, which is normally connected to the first cellular network may connect to the backup cellular network as the emergency management entity transmits the first emergency request to the backup cellular network, which contains the network identifier of the first cellular network and the first geographical area. This information can then be used by the backup cellular network and the backup cellular network can play the backup role, by way of example by emitting the network identifier of the first cellular network in the first geographical area.

Furthermore, a method is provided carried out at a radio access node of a backup cellular network, the method comprising the step of receiving a first emergency request comprising a network identifier of a first cellular network, having a radio network outage in its radio network coverage, wherein a connection to the at least one first cellular network is temporarily not available, wherein the first emergency request furthermore comprises a first geographical area, where the connection to the first cellular network is temporarily not available due to the radio network outage. The radio access network then broadcasts the network identifier of the first cellular network in the radio access network of the backup cellular network in the first geographical area.

Furthermore, the corresponding radio access node is provided comprising a memory and at least one processing unit, wherein the memory contains instructions executable by the at least one processing unit. The radio access node is operative to work as discussed above or as discussed in further detail below.

With the radio access network broadcasting the network identifier of the first cellular network, the mobile subscribers normally connecting to the first cellular network have the impression and the option to connect to the first cellular network and even more important the subscribers can connect to the backup cellular network, even in a situation when no roaming agreement exists.

Furthermore a method is provided carried out at a management node of the backup cellular network, wherein the method comprises the step of receiving a request comprising a policy how subscribers of a first cellular network should be handled in a first geographical area of the backup cellular network, where the connection to the first cellular network is temporarily not available due to a radio network outage in the radio network coverage of the first cellular network. Based on the received emergency policy the management node reconfigures a network policy for the first subscribers of the first cellular network, which are located in the first geographical area and which are connected to the backup cellular network, wherein the policy contains the information not to authenticate the first subscribers. Furthermore, a defined access point is determined in the backup cellular network configured to only handle traffic from the first subscribers.

Furthermore, the corresponding management node of the backup cellular network is provided comprising a memory and at least one processing unit, wherein the memory contains instructions executable by the at least one processing unit. The management node is operative to work as discussed above or as discussed in further detail below.

Preferably, the management node is a network node of the core network and could be implemented in a management network node of the backup cellular network. The fact that the subscribers of the first cellular network are not authenticated in the first geographical area helps to make sure that the subscribers of the first cellular network can operate in the backup cellular network and the subscribers are not refused in view of a missing authentication. Furthermore, with the help of the defined access point it is possible to separate the subscribers of the first cellular network from the subscribers of the backup network and to apply different policies to the subscribers of the first cellular network. The use of the defined access point helps to make sure that users from the backup cellular network can be separated from the subscribers of the first cellular network and the same policies can be applied to all subscribers of the first cellular network, which are temporarily allowed to use the backup cellular network.

Additionally a computer program comprising program code is provided, which is to be executed by at least one processing unit of an emergency management entity, of a radio access node or of a management node, wherein execution of the program code causes the at least one processing unit to carry out a method as discussed above or as discussed in further detail below.

Furthermore, a system is provided comprising at least two entities from the group of entities including the emergency management entity, the radio access node and the management node. Last but not least, a carrier is provided comprising the computer program, wherein the carrier is one of an electronic signal, optical signal, radio signal, and computer readable storage medium.

It is to be understood that the features mentioned above and features yet to be explained below can be used not only in the respective combinations indicated, but also in other combinations or in isolation without departing from the scope of the present invention. This of the above-mentioned aspects and embodiments described below may be combined with each other in other embodiments unless explicitly mentioned otherwise.

### BRIEF DESCRIPTION OF THE DRAWINGS

The foregoing and additional features and effects of the application will become apparent from the following detailed description when read in conjunction with the accompanying drawings, where like reference numerals refer to like elements.

FIG. 1 shows a high-level architectural view of a system involving entities which coordinate an outage at one of the operators.

FIG. 2 shows the architecture of FIG. 1 where the emergency management entity coordinates networks during an outage.

FIG. 3 shows an example flowchart of a method carried out at the emergency management entity shown in FIGS. 1 and 2 in case of an outage.

FIG. 4 shows an example flowchart of steps carried out at a backup network taking over subscribers from another network in case of an outage.

FIG. 5 shows a message exchange between the involved entities when an outage is detected in one of the cellular networks.

FIG. 6 shows an example flowchart of a method carried out at an emergency center when an outage occurs at one of the cellular networks.

FIG. 7 shows an example flowchart of a method carried out at an emergency management entity in case of an outage.

FIG. 8 shows an example flowchart of a method carried out at a radio access node when an outage occurs in another network.

FIG. 9 shows an example flowchart of a method carried out at a management node of a backup network in case of an outage at another radio access network.

FIG. 10 shows an example schematic representation of an emergency management entity.

FIG. 11 shows an example schematic representation of a radio access node of a backup cellular network.

FIG. 12 shows an example schematic representation of a management node in a backup network

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Within the context of the present application, the term “mobile entity” or “user equipment” (UE) refers to a device for instance used by a person (i.e. a user) for his or her personal communication. It can be a telephone type of device, for example a telephone or a Session Initiating Protocol (SIP) or Voice over IP (VoIP) phone, cellular telephone, a mobile station, cordless phone, or a personal digital assistant type of device like laptop, notebook, notepad, tablet equipped with a wireless data connection. The UE may also be associated with non-humans like animals, plants, or machines. A UE may be equipped with a SIM (Subscriber Identity Module) or embedded-SIM comprising unique identities such as IMSI (International Mobile Subscriber Identity), TMSI (Temporary Mobile Subscriber Identity), or GUTI (Globally Unique Temporary UE Identity) associated with the user using the UE. The presence of a SIM within a UE customizes the UE uniquely with a subscription of the user.

For the sake of clarity, it is noted that there is a difference but also a tight connection between a user and a subscriber. A user gets access to a network by acquiring a subscription to the network and by that becomes a subscriber within the network. The network then recognizes the subscriber (e.g. by IMSI, TMSI or GUTI or the like) and uses the associated subscription to identify related subscriber data. A user is the actual user of the UE, and the user may also be the one owning the subscription, but the user and the owner of the subscription may also be different. E.g. the subscription owner may be the parent, and the actual user of the UE could be a child of that parent.

In the following, an emergency management entity is explained in more detail which is aware of the situation in different cellular networks and which enables coordination of network resources in real time during an emergency or a disaster. The mechanism discussed below secures that during an emergency situation a mobile user can connect to any network operator at any time once the home public land mobile network, PLMN, becomes unavailable. The emergency management entity is aware of the situation at the different networks and is informed of any outage so that the emergency management entity may also be considered as the situation aware function, SAF. In the following, situation awareness function (SAF) and emergency management entity (EME) are used interchangeably and indicate the same entity.

The main purpose of the emergency management entity is to grant access to UEs of an affected network during an event of a disaster or emergency on demand and only for a certain period of time. This could be achieved by applying features like network sharing across operators and it is dependent on the network condition of the network, which plays the role of the backup network and takes over the subscribers from the network where the emergency occurred, also called first network hereinafter. The emergency management entity is an entity which can be located between an emergency operations center, which could be owned by local authorities or the government and the national mobile network operators with the aim to correlate the mobile and the network operators, MNO's network information and to coordinate the configuration change in one or the other direction to get a fast automated and efficient procedure.

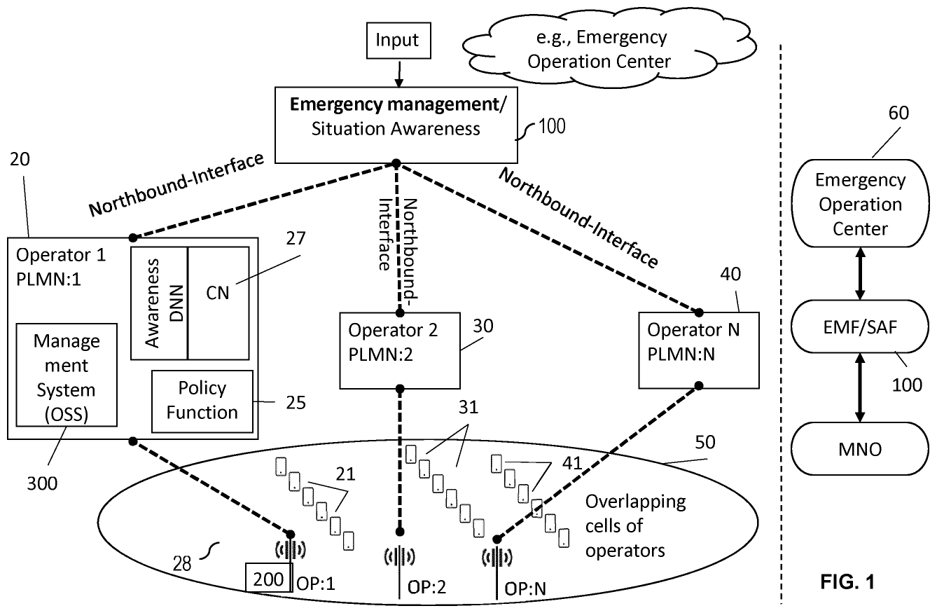

As will be discussed below a mechanism is provided to provide access to mobile broadband services to subscribers during a time of a crisis or disaster when the home PLMN (Public Land Mobile Network) is not available. FIG. 1 shows an architectural overview where an emergency management entity 100 is provided, which is in contact with different operators and different PLMNs such as the network 20, 30 and 40 shown in FIG. 1, which are operated by different operators. The different cellular networks 20, 30 or 40 each have a certain radio network coverage and there is an overlapping coverage 50 of the radio networks, where each of the networks has corresponding radio access nodes. In the overlapping area subscribers 21 are provided which are subscribers of the first PLMN. In the same way subscribers 31 are subscribers of the second PLMN 30 and subscribers 41 are subscribers to network 40. As shown on the right side of FIG. 1 the emergency management entity or situation awareness function is located between an emergency operations center 60 and the mobile network operators.

In case of a disaster, common processes can be triggered where local authorities and agencies are coordinated via an emergency response management team. The emergency management entity 100 is an entity which may be hosted in the cloud, in one of the agencies or in one of the operator's cloud and can receive up-to-date information of a disaster area and magnitude upon demand from the Emergency Operation Center 60 on the one hand while on the other hand it has a defined connection using a northbound interface towards any mobile network operator as shown in FIG. 1. Accordingly, each of the cellular networks 20, 30 or 40 are connected to the emergency management entity. Accordingly, each MNO may subscribe to the emergency management entity 100 via a northbound interface over a secure connection and the local government or regulators might enforce this subscription via regulatory agreements for disaster situations.

The emergency management entity itself can receive and exchange information with local authorities like the Emergency Operation Center 60 or is even part of it. If the Emergency Operation Center declares an emergency for a specific area, (e.g. a location fence) the emergency management entity 100 requests information on the current status especially for that area of each of the local networks 20, 30 or 40, i.e. it requests a cell status of the coverage areas. Each operator can request resources to restore services in case of an impacted infrastructure in the access network without a stringent requirement of a disaster. The emergency management entity 100 can update the emergency operation center 60 about a recovery status of a mobile infrastructure and coverage to improve an overall coordination of a crisis.

For simplification, in the example discussed below the first operator of network 20 lists all involved functions such as a policy function 25, a management system 300 and a core network 27 and a radio network 28 including a radio access node 200. The emergency management entity sends a request to each of the network operators or networks for a status of the network for a defined geographical area and the management node (OSS) 300 determines the current state of the corresponding network. Each network responds to the emergency management entity with a status of the related service and the corresponding location area. Once the data has been received and processed, the emergency management entity 100 can create an overlapping coverage map, which provides in real time a holistic view where subscribers would suffer from being disconnected.

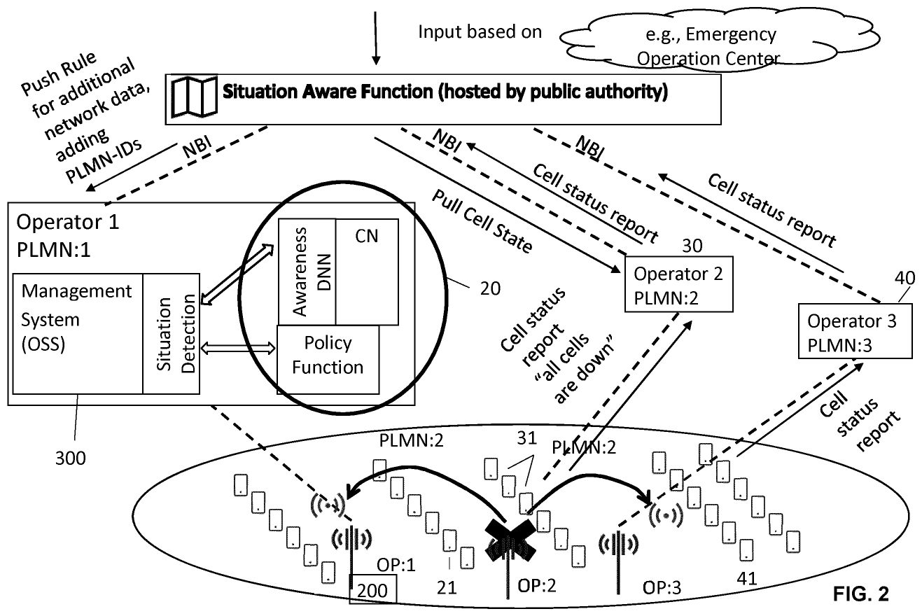

In the example given in FIG. 2 the operator of the second cellular network 30 is reporting that the entire radio sites are not operating anymore. The emergency management entity 100 can then detect the coverage gaps in the different geographical areas from the corresponding MNO and can initiate a push of a rule towards the first network 20 and the third network 40 triggering an emergency as described below. Here, the networks 20 and 40 can play the role of the backup network.

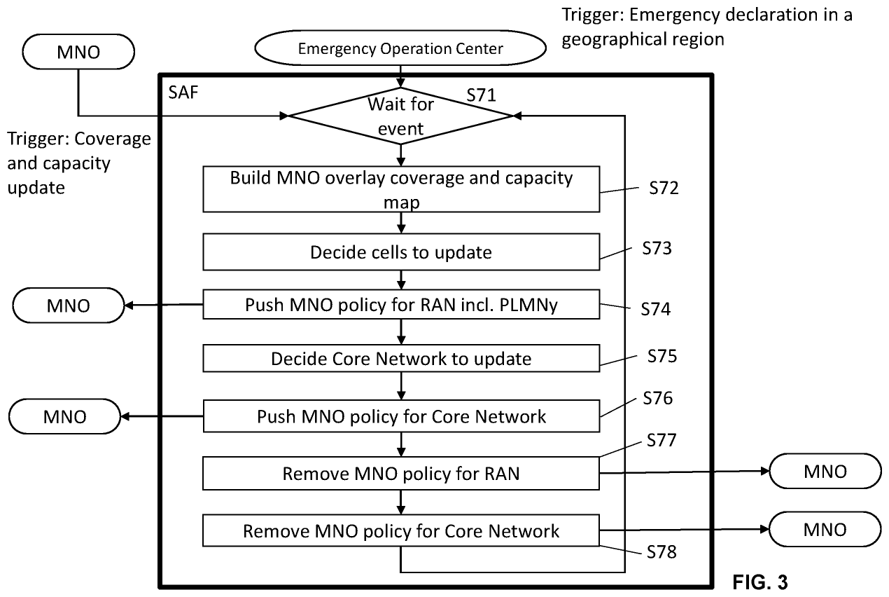

As shown in FIG. 3, the emergency management entity 100 receives from the different operator networks 20, 30 or 40 information about the coverage and a possible outage. It should be understood that a network may only send the information when there is an emergency or an outage and in case a network does not send any update, entity 100 could also assume that the corresponding network is operating correctly as long as the connection to the corresponding network is available. It is possible that the Emergency Operation Center 60 informs the emergency management entity 100 of an emergency in a certain geographical region. In this example the EOC triggers the procedure. Accordingly, in step S71 the entity 100 is waiting for an event or for a notification of an emergency. In case an emergency request is received from one of the cellular networks, the emergency management entity generates a coverage map and a capacity map which network can take over which capacity in the different geographical areas (S72). In step S73 it determines which of the cells have to be updated in view of an outage and in step S74 the entity 100 pushes the policy for the radio access network which should play the role of the backup network and this information is transmitted to the corresponding mobile network operators, in the example shown in FIG. 2, operator 1 and operator 3. Furthermore, it is determined in step S75 to update the Core network of the backup network. Accordingly, in step S76 the policy for the Core network is transmitted to the backup networks. This policy or rule could include different parameters related to capacity, the quality of service or the handling of high load and overload and the required characteristics of the impacted mobile network operator. Accordingly, this is sent to the OSS in the Core network which then derives the corresponding and proper configuration commands to the RAN and core such as the AMF, SMF or policy control, to not only provision the PLMN identifier of the network where the outage occurs but also perform tuning, by way of example on the access network for optimizing the resources of the backup network efficiently preventing overload.

Accordingly, a request is sent for the radio access network requesting the network playing the role of the backup network to transmit the network identifier of the network where the outage occurs. Furthermore, the backup network is informed of the area where the outage occurs. Before step S77 it is assumed that the other network recovers and the emergency management entity 100 is informed accordingly. As a consequence the policy for the radio access network of the backup network is removed. In the same way in step S78 the backup network is informed to remove the policy for the Core network.

Upon request from the emergency management entity 100, to provision additional PLMNs of another mobile network operator, an update on the radio access network to facilitate information in the SIB1 message and adding a dedicated access point name, APN/DNN maybe needed at the backup network. Furthermore the backup network is requested to disable authentication on the Core network for the subscribers which come from the network where the outage occurs.

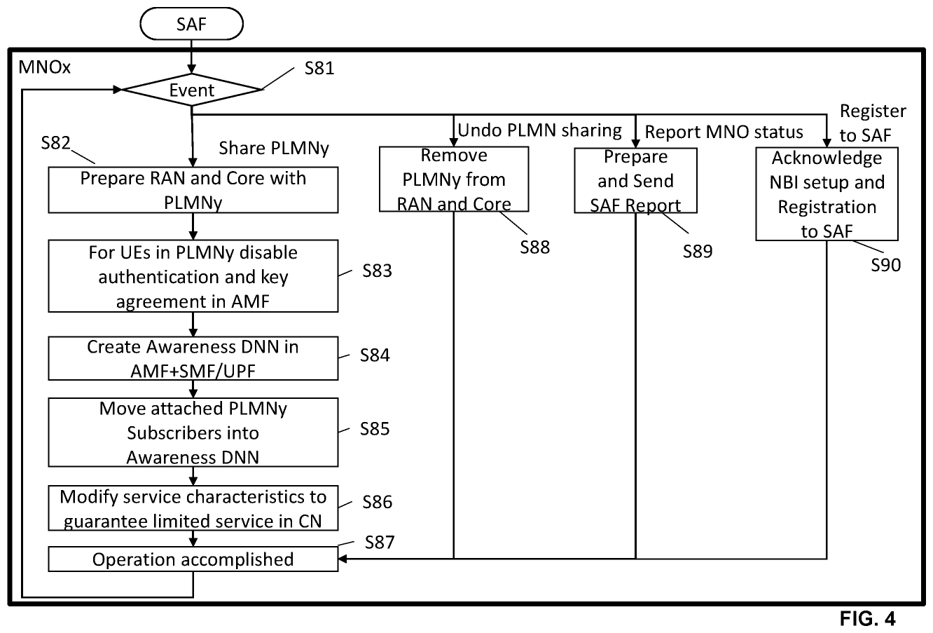

FIG. 4 describes in more detail the steps carried out at the backup network, which takes over the subscribers in the geographical area where the outage at the other network occurs. In step S81 the backup network receives information from the emergency management entity 100 that an outage occurs in one of the other networks wherein this information contains the information transmitted in step S74 and the information transmitted in step S76. Accordingly information for the radio access network is received and information for the Core network. In step S82 the access network part and the Core network part is prepared accordingly with the identifier of the first network. In step S83 for UEs of the first network attached to the backup network the authentication is disabled, Furthermore a key agreement is generated in the AMF meaning that the function of authentication is disabled and it is disabled that security keys are generated to encrypt the data as this is not possible for the OP2 subscribers where no encryption is used. In S84 a separate access point or Data Network Name, DNN or access point name, APN, is created in the AMF, SMF and UPF. In step S85 the subscribers of the first network are moved to this specific access point and in step S86 it is possible to modify the service characteristics in this access point in order to guarantee a limited service for those subscribers in the Core network. In step S87 operation is accomplished and the procedure returns back to step S81 to wait for further input. The event detected in step S81 can include the information that the first network is fully operable again so that the backup network can decide to remove the first network from the radio access network part and the Core network in step S88. Furthermore, the network prepares itself and reports on its network status in step S89 informing the entity 100 of a possible outage. In step S90 the backup network also registers to the emergency management entity 100 and sets up a northbound interface to entity 100.

Accordingly summarizing based on known 3GPP procedures a subscriber of the network such as the second network 30 in FIG. 2 would search and find a matching PLMN ID broadcast over the access network of the first or third cellular network. In the Core network of the backup networks these users of the network where the outage occurs are not authenticated and are moved into a dedicated access point, called awareness DNN in the example FIG. 4, which ensures a flexible control of mobile broadband services per subscriber. Consequently and based on the load or traffic conditions the backup network can permit, modify or even block access to specific services and internet destination with high volume traffic or traffic having a bandwidth larger than a threshold, such as traffic demanding video platforms and could only allow a basic connectivity by throttling the bandwidths for the subscribers of the first network via the policy function while having a limited impact on the home PLMN and the connected users.

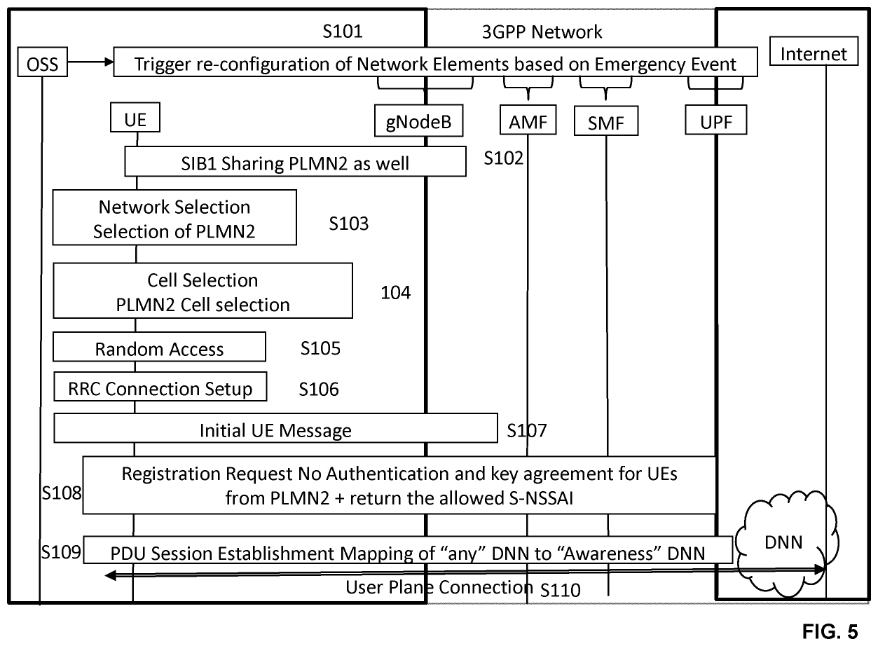

FIG. 5 outlines the UE behavior after losing connectivity to the original HPLMN (PLMN2, OP2 in FIG. 2) and transition steps including change of 3GPP procedures e.g. turn off authentication

Step S101: Upon an Emergency Event invoking the emergency management entity, a request will be sent to the Operation and Support System (OSS) of the Operator taking over Subscribers of PLMN2, i.e. the first network. Thus, triggering re-configurations of Network Elements or Functions enables basic mobile connectivity and service.

Step S102: The RAN parameters including shared PLMN2 are updated in SIB1 message.

Step S103: After initial synchronization of OP2 UEs with the network and obtaining the MIB, the UE starts to listen System Information Block Type 1 (SIB1) which is carrying cell access related information.

Step S104: PLMN selection attempting to select the HPLMN (Home PLMN of OP2) is carried out at the UE.

Step S105: If UEs of OP2 finds a suitable cell it selects that one to camp on.

Step S106: Random access procedure is used by the UEs to initiate a data transfer. The UEs also obtain uplink timing information from the initial handshake.

Step S107: UEs initiating a connection to the radio access node (gNodeB) during RRC connection setup

Step S108: gNB will send registration request to AMF. The following steps are deviations specific to the present invention:
AMF will not send an authentication request to AUSF (Authentication server Function) for user containing PLMN2, instead, AMF should directly continue with a Create Session Request towards SMF to create a GTP (GPRS Tunneling Protocol)-tunnel.
Optionally any slice identifier (S-NSSAI) and DNN signaled from the UE is modified to reach the dedicated Awareness DNN.
Qualify Awareness DNN with best effort 5QI or limited-service policy avoiding network overload is used.

Step S109: In the PDU Session Establishment the DNN is received and can be mapped to the “Awareness” DNN in conjunction with the assignment of a UE IP from the “Awareness” DNN Address range providing basic connectivity e.g., Internet.

Step S110: After successful session establishment the UE can send/receive traffic to/from the internet.

Continues monitoring of the access network can assure that after recovery of OP2, entity 100 withdraws the rule from OP1 and OP3 and removes corresponding PLMNs and triggers the release of all connected OP2 subscribers from the Core Network. Subsequent re-attach would automatically push back end-users to their original home network of PLMN2. Lastly entity 100 could declare the emergency situation as “repealed” after the mobile coverage being restored and secured for all MNOs again.

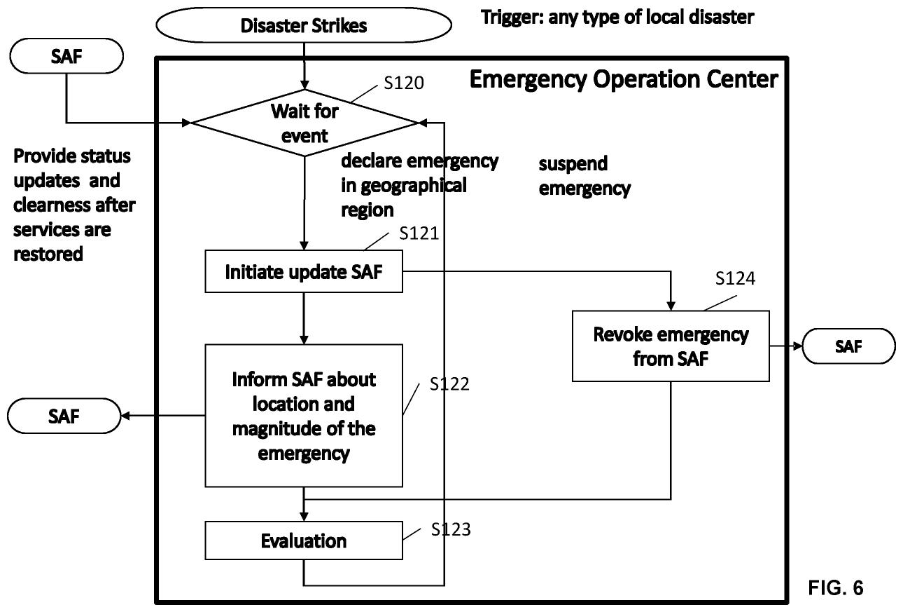

In connection with FIG. 6, it is explained in more detail how the emergency management entity informs an emergency operation center. In step S120 the Emergency Operation Center waits for an event wherein this kind of information can be received from the emergency management entity 100 or any other source. In any case in step S121 an update of the emergency management entity is initiated as the information about the disaster may be received from another source. In step S122 the emergency management entity is informed about the location and the magnitude of the emergency and in step S123 the situation is evaluated so that in case the emergency is over the emergency case can be revoked in step S124 and the emergency management entity can be informed accordingly. During emergency the emergency management entity would provide a status update of the mobile network accessibility towards the Emergency Operation Center and thereby also improves the reliability of emergency measures.

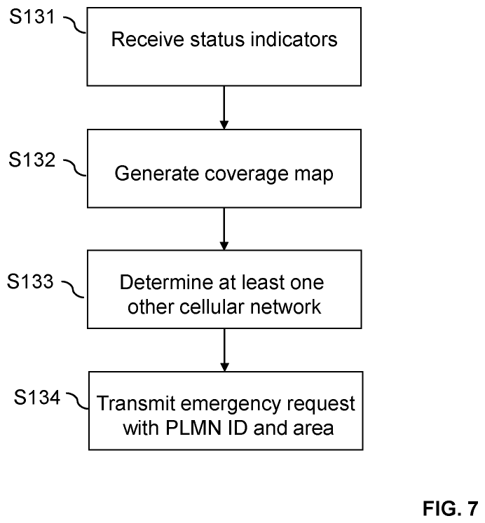

FIG. 7 summarizes some of the steps carried out at the emergency management entity in the situations discussed above. In step S131 a status indicator is received from at least one cellular network where an outage occurs, here the first cellular network wherein the indicator indicates that a radio network outage has occurred so that a connection to the corresponding cellular network is temporarily not available. It is possible that an initial trigger for requesting such a status indicator came from the EOC, but this is not necessarily the case. In step S132 a coverage map is generated by entity 100 based on the received status indicator which defines the geographical area where the connection to the first cellular network is temporarily not available due to the radio network outage. The entity 100 determines at least one backup cellular network, which can provide coverage in this first geographical area and transmits to this backup cellular network a first emergency request, which comprises a network identifier of the first cellular network and the first geographical area (step S134). This requests the backup cellular network to broadcast the network identifier of the first network at least in the first geographical area.

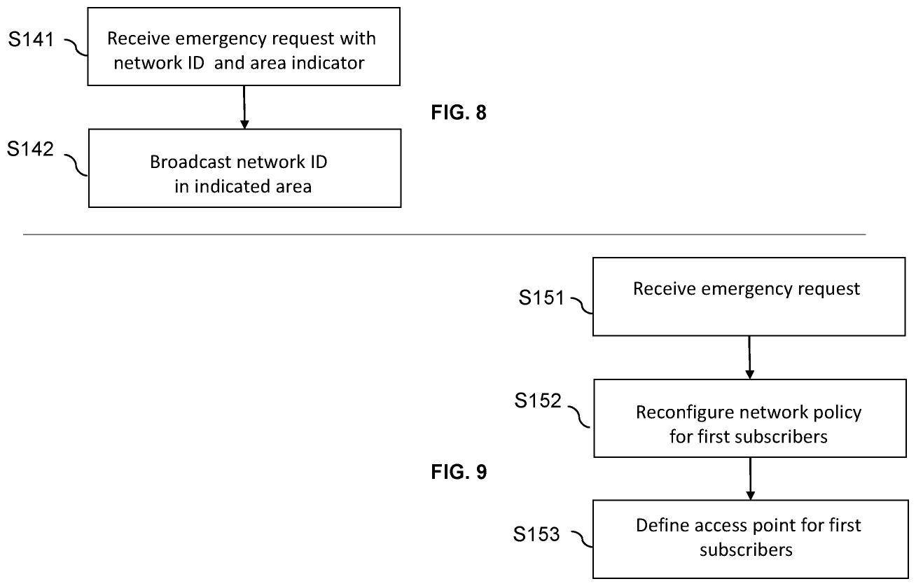

FIG. 8 summarizes some of the steps carried out at the corresponding radio access node of the backup cellular network, which takes over the subscribers from the first network where the failure occurred. In step S141 the first emergency request is received (e.g. from the OSS) which comprises the network identifier of the first cellular network where the radio network outage has occurred. The request furthermore comprises the first geographical area where the connection to the first cellular network is temporarily not available due to the outage. Based on the received request the radio access node will broadcast in step S142 the network identifier of the first cellular network in the radio access network of the backup cellular network in the first geographical area.

FIG. 9 summarizes some of the steps carried out at a Management node of the backup network. This node can be the OSS for the radio access network or the OSS for the core. This node could be further implemented by the management system. In one step S151 the management node of the Core network receives a request which contains the emergency policy how subscribers of the first cellular network should be handled in the first geographical area where the connection to the first network is not available due to the outage. In step S152 a network policy is reconfigured for the first subscribers based on the received emergency policy, wherein the policy inter alia contains the information not to authenticate the first subscribers. The network policy can correspond to the emergency policy however the network policy can include additional information not present in the emergency policy. In step S153 furthermore, an access point is defined in the backup cellular network, which is configured to only handle the traffic from the first subscribers.

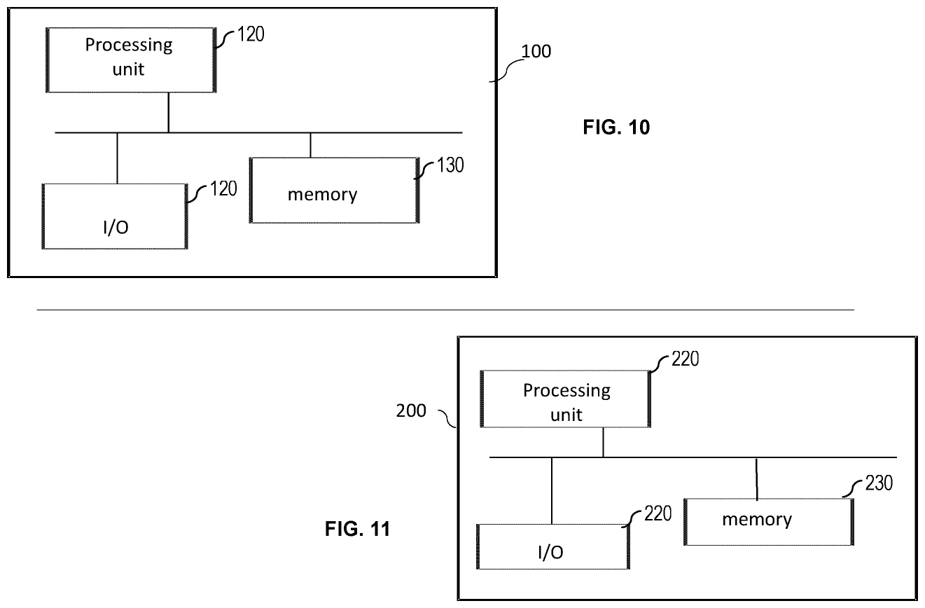

FIG. 10 shows a schematic architectural view of the emergency management entity 100 which can carry out the above discussed steps of a coordination of a network outage. Entity 100 comprises an interface 110, which is provided for transmitting data or control messages to other entities and is configured to receive data and/or control messages from other entities such as the different mobile networks or the Emergency Operation Center. The entity 100 furthermore comprises a processing unit 120, which is responsible for the operation of the entity 100. The processing unit 120 comprises one or more processors and can carry out instructions stored on a memory 130, wherein the memory may include a read-only memory, a random access memory, a mass storage, a hard disk or the like. The memory can furthermore include suitable program code to be executed by the processing unit 120 so as to implement the above described functionalities where the emergency management entity is involved. It should be understood that entity 100 may not be implemented in a single housing, but a cloud implementation is possible where the function entities described in FIG. 10 are distributed over different locations.

FIG. 11 shows a schematic architectural view of a radio access node 200 which can operate as discussed above. The radio access node 200 comprises an interface 210 provided for transmitting user data or control messages to other entities and configured to receive user data or control messages from other entities. The interface 220 may be configured to broadcast the network identifier of the network identifier of the home network. The radio access node 200 furthermore comprises a processing unit 220, which is responsible for the operation of the radio access node 200. The radio access node 200 can comprise one or more processors 220 and can carry out instructions stored on a memory 230, wherein the memory may include a read-only memory, a random access memory, a mass storage, a hard disk or the like. The memory can furthermore include suitable program code to be executed by the processing unit 220 so as to implement the above described functionalities in which the radio access node 200 is involved. It should be understood that the radio access node may not be implemented in a single housing, and a clout implementation is possible.

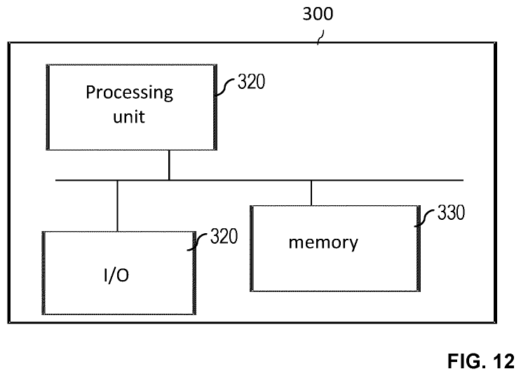

FIG. 12 shows a schematic architectural view of a management node of the backup cellular network wherein the management node is located in a Core network of the backup cellular network, wherein the node could be implemented by the management system. The management node 300 comprises an interface 310 configured to transmit data and control messages to other entities and configured to receive data and control messages from other entities. The entity 300 furthermore comprises a processing unit 320 responsible for the operation of the management node 300. The processing unit 320 comprises one or more processors and can carry out instructions stored on a memory 330, wherein the memory may include a read-only memory, a random access memory, a mass storage, a hard disk or the like. The memory can furthermore include suitable program code to be executed by the processing unit 320, so as to implement the above-described functionalities in which the management node 300 is involved.

From the above said some general conclusions can be drawn for the different entities and nodes involved in the procedure discussed above. As far as the emergency management entity is concerned, a first emergency request is transmitted to the backup cellular network which contains the network identifier and which can request the backup cellular network to broadcast the network identifier of the first cellular network in a radio access network park of the backup cellular network, especially in the first geographical area.

Furthermore, the emergency management entity may transmit a second request to the backup cellular network, which comprises a policy how subscribers of the first cellular network should be handled in the backup network. This second emergency request could comprise request for the backup cellular network to set up a dedicated access point for the subscribers of the first cellular network, which access the backup cellular network in the first geographical area. Furthermore, the second emergency request can contain information or a request not to authenticate to subscribers after first cellular network which access the backup cellular network and the first geographical area.

The first emergency request can contain information such as quality of service parameters for the subscribers of the first cellular network accessing the backup cellular network in the first geographical area. Furthermore, the first emergency request can contain information relating to a network capacity to be applied to subscribers of the first cellular network in the backup cellular network in case of a high load in the backup network

The emergency management entity may furthermore receive a request from the first cellular network, a clearance message that the outage in the in the first cellular network is overcome. Furthermore, entity 100 can transmit a first termination request to the backup cellular network, which requests the backup cellular network to stop broadcasting the network identifier of the first network in the first geographical area. Furthermore, a second termination request can be transmitted to the backup cellular network, which requests the backup cellular network to remove the policy how the subscribers of the first cellular network should be handled in the backup network.

As far as the radio access node is concerned which broadcast the network identifier of the first cellular network, the broadcasting of the network identifier may be limited to the first geographical area.

Furthermore the radio access node may receive a termination request requesting the backup cellular network to stop broadcasting the network identifier of the first cellular network in the first geographical area, wherein the broadcasting of the network identifier of the first cellular network is stopped in response to the request.

As far as the management node of the backup cellular network is concerned, this node may distribute the policy for the first subscribers in the backup cellular network and may trigger a procedure that the data traffic generated by the first subscribers is handled at the defined access point, which was determined to handle the complete traffic of all first subscribers in the first geographical area.

The policy may be generated such that when a load present in the backup cellular network is higher than a threshold, services for the first subscribers requiring bandwidths higher than a first threshold value, are not permitted.

Summarizing the solution discussed above enables an automatic situation awareness in mobile networks for a National Emergency Operations Agency during an emergency to recover the basic communication services of impacted end-users belonging to different PLMNs on demand. The solution discussed above has the advantage for the Emergency Operations Center that an automatic regional declaration of emergency, a revoke and update information for all mobile network operators is possible. The network deployment information can remain confidential and the perception for the Mobile Network Operator(s) can be increased by supporting potential emergency situations for the subscribers. The Mobile Network Operator(s) could request during a network outage, which is not caused by a disaster, a service support as discussed above. The end user and subscriber has the benefit to obtain connectivity via other cellular networks in the area to obtain basic communication without any reconfiguration in the device itself.

1. A method comprising, at an emergency management entity:
receiving, from at least a first cellular network a status indicator indicating a radio network outage in its radio network coverage, where a connection to the at least first cellular network is temporarily not possible;
generating a coverage map based on the status indicator indicating a first geographical area where the connection to the first cellular network is temporarily not available due to the radio network outage;
determining at least one backup cellular network providing coverage in the first geographical area; and
transmitting, to the at least one backup cellular network, a first emergency request which comprises a network identifier of the first cellular network and the first geographical area.

2. The method of claim 1, wherein the first emergency request requests the at least one backup cellular network to broadcast the network identifier of the first cellular network in a radio access network part of the backup cellular network.

3. The method of claim 1, further comprising transmitting to the at least one backup cellular network a second emergency request comprising a policy how subscribers of the first cellular network should be handled in the backup network.

4. The method of claim 3, wherein second emergency request comprises at least one of the following:
a request for the at least one backup cellular network to set up a dedicated access point for subscribers of the first cellular network accessing the at least one backup cellular network in the first geographical area; and
a request not to authenticate the subscribers of the first cellular network accessing the at least one backup cellular network in the first geographical area.

5. The method of claim 1, wherein the first emergency request comprises at least one of the following:
Quality of Service parameters for the subscribers of the first cellular network accessing the at least one backup cellular network in the first geographical area; and
information relating to a network capacity to be applied to subscribers of the first cellular network in the at least one backup cellular network in case of a high load in the at least one backup cellular network.

6. The method of claim 1, further comprising:
receiving from the first cellular network a clearance message that the radio network outage in the first cellular network is overcome;
transmitting a first termination request to the at least one backup cellular network requesting the at least one backup cellular network to stop broadcasting the network identifier of the first cellular network in the first geographical area.

7. The method of claim 6, further comprising transmitting a second termination request to the at least one backup cellular network, requesting the at least one backup cellular network to remove the policy how the subscribers of the first cellular network should be handled in the backup network.

8. A method comprising, at a radio access node of a backup cellular network:
receiving a first emergency request comprising a network identifier of a first cellular network having a radio network outage in its radio network coverage, where a connection to the at least first cellular network is temporarily not possible, and comprising a first geographical area where the connection to the first cellular network is temporarily not available due to the radio network outage; and
broadcasting the network identifier of the first cellular network in a radio access network of the backup cellular network in the first geographical area.

9. The method of claim 8, wherein the broadcasting of the network identifier of the first cellular network is limited to the first geographical area.

10. The method of claim 8, further comprising receiving a termination request requesting the at least one backup cellular network to stop broadcasting the network identifier of the first cellular network in the first geographical area, wherein broadcasting the network identifier of the first cellular network is stopped in response to the request.

11.-13. (canceled)

14. An emergency management entity comprising a memory and at least one processing unit, the memory containing instructions executable by the at least one processing unit to configure the emergency management entity to:
receive, from at least a first cellular network, a status indicator indicating a radio network outage in its radio network coverage, where a connection to the corresponding cellular network is temporarily not possible;
generate a coverage map based on the status indicator indicating a first geographical area where the connection to the first cellular network is temporarily not available due to the radio network outage;
determine at least one backup cellular network providing coverage in the first geographical area; and
transmit, to the at least one backup cellular network, a first emergency request which comprises a network identifier of the first cellular network and the first geographical area.

15. The emergency request management entity of claim 14, wherein the first emergency request requests the at least one backup cellular network to broadcast the network identifier of the first cellular network in a radio access network part of the backup cellular network.

16. The emergency request management entity of claim 14, further configured to transmit to the at least one backup cellular network a second emergency request comprising a policy how subscribers of the first cellular network should be handled in the backup network.

17. The emergency request management entity of claim 16, wherein the second emergency request comprises at least one of the following:
a request for the at least one backup cellular network to set up a dedicated access point for subscribers of the first cellular network accessing the at least one backup cellular network in the first geographical area; and
a request not to authenticate the subscribers of the first cellular network accessing the at least one backup cellular network in the first geographical area.

18. The emergency request management entity of claim 14, wherein the first emergency request comprises at least one of the following:
Quality of Service parameters for the subscribers of the first cellular network accessing the at least one backup cellular network in the first geographical area; and
information relating to a network capacity to be applied to subscribers of the first cellular network in the at least one backup cellular network in case of a high load in the at least one backup cellular network.

19. The emergency request management entity of claim 14, further configured to:
receive from the first cellular network a clearance message that the radio network outage in the first cellular network is overcome; and
transmit a first termination request to the at least one backup cellular network requesting the at least one backup cellular network to stop broadcasting the network identifier of the first cellular network in the first geographical area.

20. The emergency request management entity of claim 19, further configured to transmit a second termination request to the at least one backup cellular network, requesting the at least one backup cellular network to remove the policy how the subscribers of the first cellular network should be handled in the backup network.

21. A radio access node of a backup cellular network comprising a memory and at least one processing unit, the memory containing instructions executable by the at least one processing unit, to configure the radio access node to:
receive a first emergency request comprising a network identifier of a first cellular network having a radio network outage in its radio network coverage, where a connection to the at least first cellular network is temporarily not possible, and comprising a first geographical area where the connection to the first cellular network is temporarily not available due to the radio network outage; and
broadcast the network identifier of the first cellular network in a radio access network of the backup cellular network in the first geographical area.

22. The radio access node of claim 21, further configured to limit the broadcasting of the network identifier of the first cellular network to the first geographical area.

23. The radio access node of claim 21, further configured to receive a termination request requesting the at least one backup cellular network to stop broadcasting the network identifier of the first cellular network in the first geographical area, and to stop the broadcasting of the network identifier of the first cellular network in response to the request.

24.-31. (canceled)
